(19) United States
(12) Patent Application Publication
(10) Pub. No.: US 2012/0014361 A1
(43) Pub. Date: Jan. 19, 2012

(54) WIRELESS COMMUNICATION SYSTEM AND IDLE STATE OPERATION METHOD THEREOF

(75) Inventors: Jung Soo Jung, Gyeonggi-do (KR); Soeng Hun Kim, Gyeonggi-do (KR); Kyeong In Jeong, Gyeonggi-do (KR); Chae Gwon Lim, Seoul (KR)

(73) Assignee: SAMSUNG ELECTRONICS CO., LTD., Suwon-city, Gyeonggi-do (KR)

(21) Appl. No.: 13/142,703

(22) PCT Filed: Dec. 22, 2009
(86) PCT No.: PCT/KR09/07656

§ 371 Date: Sep. 26, 2011

(30) Foreign Application Priority Data
Dec. 29, 2008 (KR) 10-2008-0135357

(51) Int. Cl. H04W 74/00

(52) U.S. Cl. 370/338

(57) ABSTRACT

A wireless communication system and method for operation of the wireless communication system in idle mode is provided to avoid downlink inter-cell interferences. The idle state operation method of a base station for a wireless communication according to the present invention includes setting a first discontinuous transmission cycle and a first transmission transition period; transmitting downlink signals at the first discontinuous transmission cycle within the first transmission transition period; setting a second discontinuous transmission cycle and a second transmission transition period when the first transmission transition period ends; and transmitting the downlink signal at the second discontinuous transmission cycle within the second transmission transition period.

### TECHNICAL FIELD

The present invention relates to wireless communications and, in particular, to a wireless communication system and method for operation of the wireless communication system in idle mode.

### BACKGROUND ART

With the advance of communication technologies, the boundary between fixed and mobile services has increasingly become blurred.

Recently, fixed service providers are investing in the Internet Protocol telephony represented by Voice over Internet Protocol (VoIP) as part of broadband Internet access service based on the Wireless Local Area Network (WLAN) connection to compete against the wireless voice and data service provided by the wireless service providers, under the objective of fixed-mobile convergence (FMC). In contrast, the wireless service providers are driving Fixed Mobile Substitution (FMS) with the introduction of home network service such as homezone service to provide the user with fixed voice service in indoor environment. In such omnidirectional competition, a small cellular base station called “femtocell” designed for use in a home or small business is introduced as an alternative way of the wireless service providers to deliver the benefits of the FMC.

The femtocell, or femto base station, is a small cellular base station operating with the same wireless access technology as the typical cellular base station but has some distinguishable characteristics as compared to the typical macro base station and repeater. First, the femto base station accesses the service provider's network via a public Internet rather than private network. Second, the femto base station is a user premises device installed and managed by the user rather than the service provider. Third, the femto base station supports auto-configuration and optimized performance to help the user install and manage. Fourth, the femto base station supports a limited number of accesses about as many as family members and has independent radio management function unlike the typical repeater. Finally, the femto base stations can be deployed in high density as compared to the macro base stations.

Since the femto base station uses the same radio access technology as the cellular network having the nationwide service coverage, the user can enjoy the benefits of service coverage expansion without purchase of an additional handset, high speed data service, and cheap billing rate of public network use. FIG. 1 is a diagram illustrating an operation principle of a wireless communication system supporting a femtocell. As shown in FIG. 1, the user can access a cellular network 130 via an Internet Service Provider's network 120 by means of a femto base station 111 installed in a home.

### DISCLOSURE OF INVENTION

### Technical Problem

In the wireless communication system structured as shown in FIG. 1, since the femto and macro base stations are operating with the same radio access technology, interference is likely to occur among the macro and other femto base stations. FIG. 2 is a diagram illustrating an exemplary situation where mobile terminal experiences the interference in the wireless communication system. In FIG. 2, the mobile terminal 141 connected to a macro base station 131 near the radio coverage of a femto base station 111 can be interfered by a femto base station 111 serving another mobile terminal 143. That is, the signal transmitted from the femto base station 111 to the second mobile terminal 143 can act as the inference to the first mobile terminal 141 served by the macro base station 131.

### Solution to Problem

In order to solve the above problems of prior arts, the present invention provides a wireless communication system and an idle state operation method of the wireless communication system.

In accordance with an exemplary embodiment of the present invention, an idle state operation method of a base station for a wireless communication includes setting a first discontinuous transmission cycle and a first transmission transition period; transmitting downlink signals at the first discontinuous transmission cycle within the first transmission transition period; setting a second discontinuous transmission cycle and a second transmission transition period when the first transmission transition period ends; and transmitting the downlink signal at the second discontinuous transmission cycle within the second transmission transition period.

In accordance with another exemplary embodiment of the present invention, a wireless communication system includes a base station which sets a first discontinuous transmission cycle and a first transmission transition period, transmits downlink signals at the first discontinuous transmission cycle within the first transmission transition period, sets a second discontinuous transmission cycle and a second transmission transition period when the first transmission transition period ends, and transmits the downlink signal at the second discontinuous transmission cycle within the second transmission transition period; and at least one mobile terminal which receives the downlink signal and acquires information by analyzing the received downlink signal.

### Advantageous Effects of Invention

The wireless communication system and idle state operation method of the wireless communication system according to the present invention allows the base stations to transmit downlink signal discontinuously, thereby avoiding downlink inter-cell interferences.

### BRIEF DESCRIPTION OF DRAWINGS

The above and other objects, features and advantages of the present invention will be more apparent from the following detailed description in conjunction with the accompanying drawings, in which:

FIG. 1 is a diagram illustrating an operation principle of a wireless communication system supporting a femtocell;

FIG. 2 is a diagram illustrating an exemplary situation where mobile terminal experiences the interference in the wireless communication system;

FIG. 3 is a diagram illustrating operation of a base station in idle state according to an exemplary embodiment of the present invention;

FIG. 4 is a diagram illustrating operation of a base station in idle state according to another exemplary embodiment of the present invention;

FIG. 5 is a block diagram illustrating configurations of a base station and a mobile terminal in a wireless communication system according to an exemplary embodiment of the present invention;

FIG. 6 is a flowchart illustrating an idle state operation method of a base station according to an exemplary embodiment of the present invention;

FIG. 7 is a flowchart illustrating a discontinuous transmission mode of the idle state operation method in FIGS. 6; and

FIG. 8 is a flowchart illustrating an idle state operation method of a mobile terminal according to an exemplary embodiment of the present invention.

### MODE FOR THE INVENTION

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

In the following description, the efficient operations of a base station and mobile terminals in idle mode in which no radio resource or communication channel is allocated between them. In case that no mobile terminal is in the coverage of the base station or all the mobile terminals are in idle mode, the base station stops downlink transmission or performs the downlink transmission periodically to mitigate inter-cell interference. If all the mobile terminals within the coverage of the base station are in idle state, the base station is regarded as in idle state. When all the base stations within the cell, the corresponding base station can adjust the downlink transmission cycle based on its idle mode duration and call signal reception probabilities of the mobile terminals.

In a wireless communication system according to an exemplary embodiment of the present invention, the base station defines n downlink discontinuous transmission cycles depending on the time duration in which the base station operates in the idle state. In the following description, the term “discontinuous transmission cycle” denotes a time interval at which the base station transmits downlink signal in idle state and which increments in stepwise manner of P0, P1, . . . , P(n−1). The term “transmission transition period” denotes a time duration in which the discontinuous transmission cycle repeats to transmit the downlink signal and which increments in stepwise manner of T0, T1, . . . , T(n−1). For instance, the base station transmits at least one downlink signal at an interval of a specific discontinuous transmission cycle during a specific period repetition duration. The term “transmission cycle duration” denotes a period during which the base station actually transmits the downlink signal after the expiry of the discontinuous transmission cycle and is expressed as TX_Cycle_Dur. The transmission cycle duration can be composed of one more subframes or one or more slots.

In an exemplary embodiment of the present invention, when the base stations powers on initially, it sets the discontinuous transmission cycle to P0 and sets the TX_cycle duration. At the time when the P0 expires, the base station starts transmission of the downlink signal during the TX_cycle duration. If the idle state of the mobile terminal is maintained during the signal transmission time T0, the base station resets the discontinuous transmission cycle to P1 and transmits the downlink signal at the time when the P1 expires. In this manner, the base station maintains the idle state for T(x) with the downlink transmission during P(x) and increases the transmission transition period to T(x) and the discontinuous transmission cycle to P(x) repeatedly.

Here, the transmission transition period can be changed depending on the value of n or fixed as an absolute value. In the wireless communication system according to an exemplary embodiment of the present invention, the base station can maintains the length of the transmission transition period in which a specific discontinuous transmission cycle is repeated for the downlink signal transmission. That is, the base station can change the downlink discontinuous transmission cycle from P(x) to P(x+1) at a uniform time interval. Here, the transmission transition periods (i.e. T0, T1, . . . , T(n−1)) corresponding to the discontinuous transmission cycles (i.e. P0, P1, . . . , P(n−1)) can be determined depending on a subframe number, a slot number, or a sequence number of transmission cycle duration (counted from system time 0).

In the wireless communication system according to an exemplary embodiment of the present invention, the base station transmits the downlink signal during the preset transmission cycle duration whenever the discontinuous transmission cycle expires, and stops transmission during the rest time. At each signal transmission duration, the base station can transmit reference signal and pilot signal along with control signal carrying the downlink control information. The base station can broadcast the information on the discontinuous transmission cycle, transmission transition period, and transmission cycle duration on a downlink broadcast channel within the cell at every signal transmission cycle. Also, the base station can transmit the information on the discontinuous transmission cycle, transmission transition period, and transmission cycle duration to the access-permitted mobile terminals by means of unicast messages.

In the wireless communication system according to an exemplary embodiment of the present invention, the base station can determine a downlink signal transmission time point using a transmission offset as well as the discontinuous transmission cycle. This can distribute the downlink signal transmission times of the base stations by avoiding neighbor base stations from transmitting signals at the same transmission period. If the transmission offset is set, the base station can transmit the downlink signal before or after the transmission period as much as the transmission offset. The transmission offset also can be composed of one or more subframes or one or more slots.

In the wireless communication system according to an exemplary embodiment of the present invention, when an uplink access of the mobile terminal is detected or a connection is established with the mobile terminal, the base station can initialize the discontinuous transmission cycle and stop discontinuous transmission of the downlink signal to maintains continuous transmission until the connections to all the mobile terminals are released.

In the wireless communication system according to an exemplary embodiment of the present invention, the mobile terminal can receive the information on the discontinuous transmission cycle, transmission transition period, and transmission cycle duration used in the idle state from a specific base station and stores the information in advance. Using the discontinuous transmission cycle, transmission transition period, and transmission cycle duration received from the base station, the mobile terminal can calculate the accurate discontinuous downlink signal transmission time point.

In the wireless communication system according to an exemplary embodiment of the present invention, the mobile terminal monitors the downlink channel to determine the transmission duration of the base station. The mobile terminal also extracts the information required to configure the uplink transmission channel for transmitting uplink signal from the downlink signal received in the downlink duration. For instance, the mobile terminal can acquire the information related the configuration of the uplink channel from the overhead message or control information carried by downlink control signal. The mobile terminal also can calculates the initial transmission power for transmitting the uplink signal based on the received signal strength information extracted from the downlink reference signal and/or pilot signal. When the downlink signal carrying the control information is received, the mobile terminal can store the control information for a predetermined time duration and use the stored control information in the next uplink transmission. In this manner, the mobile terminal can reduce the uplink transmission delay caused by waiting for the receipt of the control information.

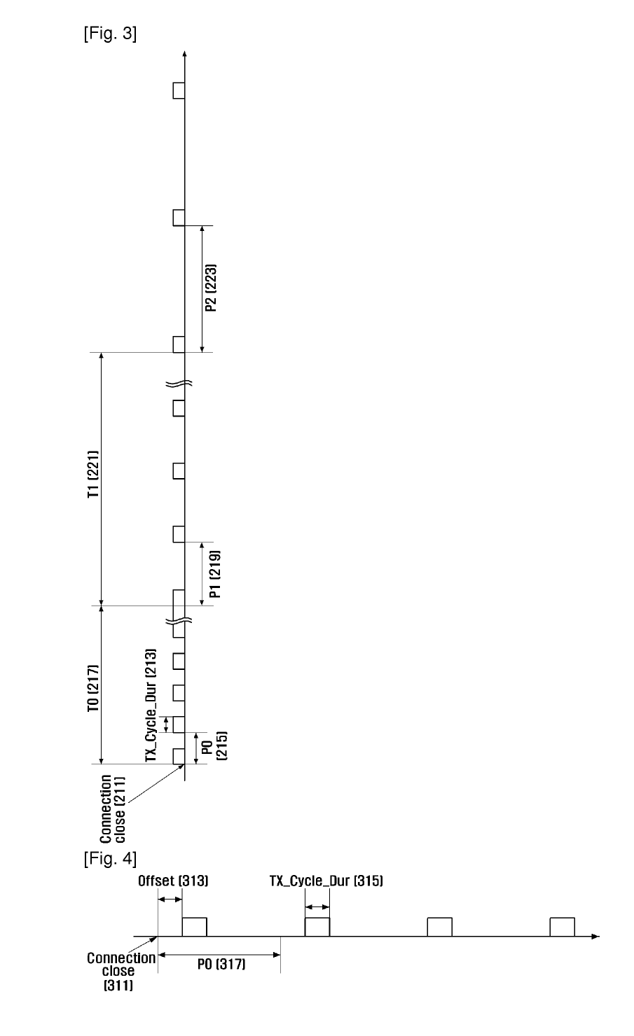

FIG. 3 is a diagram illustrating operation of a base station in idle state according to an exemplary embodiment of the present invention. In the exemplary embodiment of FIG. 3, it is assumed that TX_Cycle_Dur is a fixed absolute time duration.

Referring to FIG. 3, the base station enters the idle state when all the connections between the base station and the mobile terminals are closed. That is, if the base station enters the idle state at the connection close point 211, it transmits the downlink signal during the transmission cycle duration (TX_Cycle_Dur) repeating at the discontinuous transmission cycle P0 within the transmission transition period T0. If the transmission transition period T0 elapses from the connection close point 211, the base station transmits the downlink signal during the transmission cycle 213 repeating at the discontinuous transmission cycle P1 219 within the transmission transition period T1 221. In the same manner, if the transmission transition period T1 221 elapses from the end point of the T0 217, the base station transmits the downlink signal during the transmission cycle 213 repeating at the discontinuous transmission cycle P2 223 with the next level transmission transition period.

FIG. 4 is a diagram illustrating operation of a base station in idle state according to another exemplary embodiment of the present invention. In the exemplary embodiment of FIG. 4, it is assumed that the TX_Cycle_Dur is a fixed absolute time duration and a transmission offset is set along with the discontinuous transmission cycle P.

Referring to FIG. 4, the base station enters the idle state when all the connections between the base station and the mobile terminals are closed. That is, if the base station enters the idle state at the connection close point 311, it transmits the downlink signal during the transmission cycle duration (TX_Cycle_Dur) 315 repeating at the discontinuous transmission cycle P0. Particularly, the transmission cycle duration (TX_Cycle_Dur) is delayed as much as a predetermined length of offset 313.

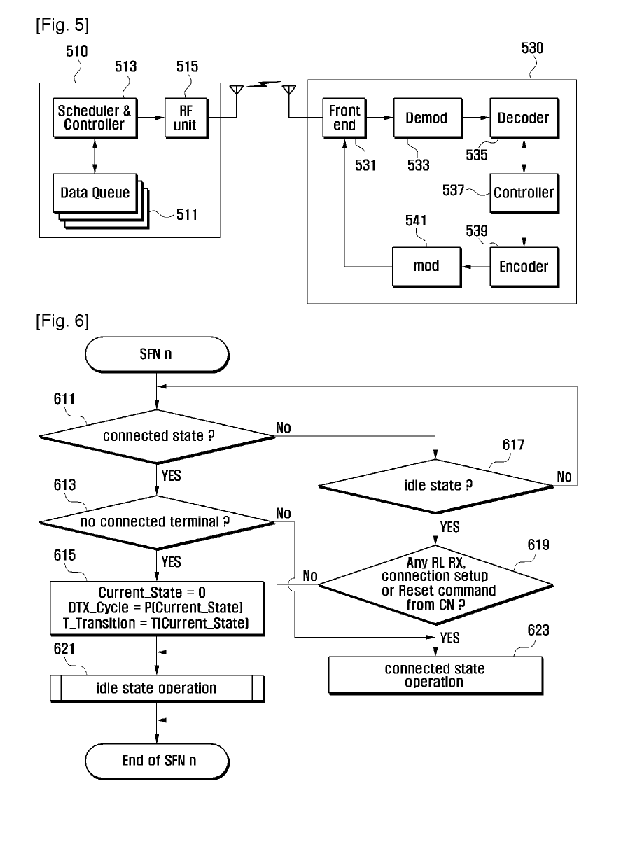

FIG. 5 is a block diagram illustrating configurations of a base station and a mobile terminal in a wireless communication system according to an exemplary embodiment of the present invention.

As shown in FIG. 5, the base station 510 according to an exemplary embodiment of the present invention includes a data queue 511, a scheduler and controller 513, and a Radio Frequency (RF) unit 515.

The data queue 511 buffers the data delivered from upper layer network entity (not shown) per terminal or per service. The scheduler and controller 513 performs scheduling the data queued in the data queue 511 in consideration of the downlink channel condition information transmitted by mobile terminals, service types, and scheduling fairness. The RF unit 55 transmits radio signals carrying the data to the corresponding mobile terminals. If all the mobile terminals within the cell under the control of the base station 510 are in idle state, the base station 510 adjusts the downlink discontinuous transmission cycle according to an exemplary embodiment of the present invention. Here, the scheduler and controller 513 determines the downlink discontinuous transmission cycle depending on an idle mode sojourn time during which the base station has stayed in idle state and reception probabilities of the mobile terminals.

As shown in FIG. 5, the mobile terminal 530 according to an exemplary embodiment of the present invention includes a front end 531, a demodulator 533, a decoder 535, a controller 537, an encoder 539, and a modulator 541.

The front end 531 is responsible for transmitting and receiving radio signals to and from the base station 510. The demodulator 533 demodulates the received signal, and the decoder 535 decodes the signal output by the demodulator 533. When it is required to connect to the base station 510 operating in idle state, the controller 537 scans the downlink channel to search for the transmission cycle duration of the base station 510. The controller 537 receives the downlink signal through the transmission cycle duration of the base station 510 and acquires the information required for configuring the uplink transmission channel from the received downlink signal. The encoder 539 encodes the data to be transmitted through the uplink channel based on the information acquired from the received downlink signal. The modulator 541 modulates the signal output by the encoder 539.

FIG. 6 is a flowchart illustrating an idle state operation method of a base station according to an exemplary embodiment of the present invention.

Referring to FIG. 6, the base station 510 performs the idle state operation every subframe (or slot) n as a physical layer transmission time unit. At the beginning of the n^{th} subframe (or slot), the base station 510 determines whether the base station 510 is in connected state (611). If it is determined that the base station 510 is in the connected state, the base station 510 determines whether there is a connected terminal (613).

If it is determined that there is no connected terminal at step 613, the base station 510 initializes the discontinuous transmission cycle, transmission transition period, and transmission cycle duration (615). At this time, the base station 510 sets the current state identifier (Current_State) to 0 and initializes the discontinuous transmission cycle (DTX_Cycle), i.e. P(x), to P0 and the transmission transition period (T_Transition), i.e. T(x) to T(0). Next, the base station 510 operates in idle state (621). In the idle state, the base station 510 transmits the downlink signal discontinuously. Although the base station 510 determines the idle state entry based on whether there is no connected mobile terminal, the present invention is not limited thereto. For instance, the base station 510 can be configured to determine the idle state entry based on the connected state sojourn time, service provider's configuration value, or at least one other parameter.

If it is determined that the base station 510 is not in the connected state at step 611, the base station 510 determines whether the base station 510 is in idle state (617). If it is determined that the base station 510 is idle mode state, the base station 510 determines whether to transition to the connected state is required (619). At this time, the base station 510 checks whether there is an uplink data or access attempt from the mobile terminal, a connection request form the mobile terminal 530, a connection request from the system for the mobile terminal 530, or a state transition command from the system.

Next, if it is determined that no transition to the connected state is required, the procedure goes to step 621. Accordingly, the base station 510 stays in the idle state to transmit the downlink signal in the discontinuous transmission mode.

If it is determined that there is a connected terminal at step 613, the base station 510 stays in the connected state (623). Also, if it is determined that transition to the connected state is required at step 619, the base station 510 transitions to the connected state (623). In the connected state, the base station 510 transmits the downlink signal in continuous transmission mode.

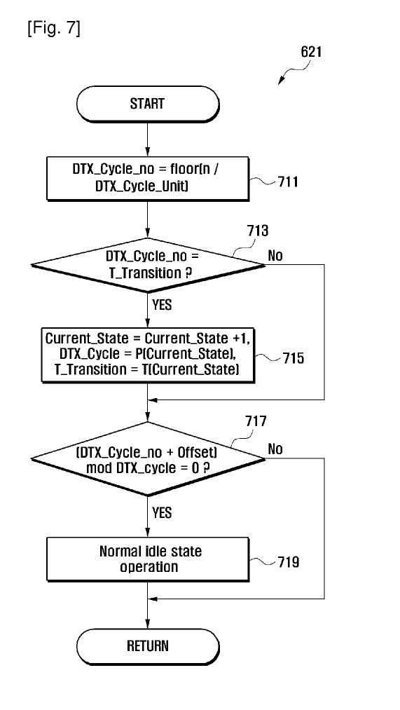

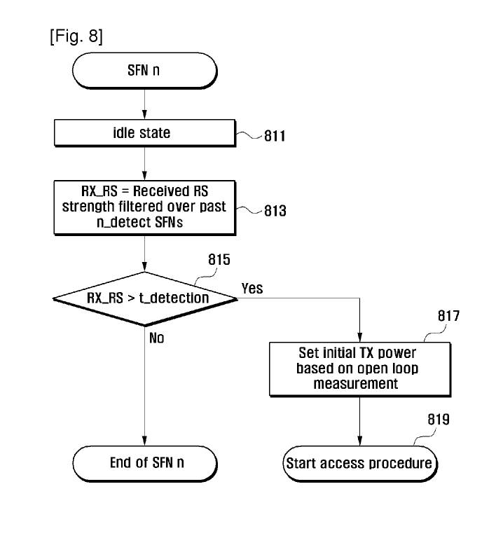

FIG. 7 is a flowchart illustrating a discontinuous transmission mode of the idle state operation method in FIG. 6.

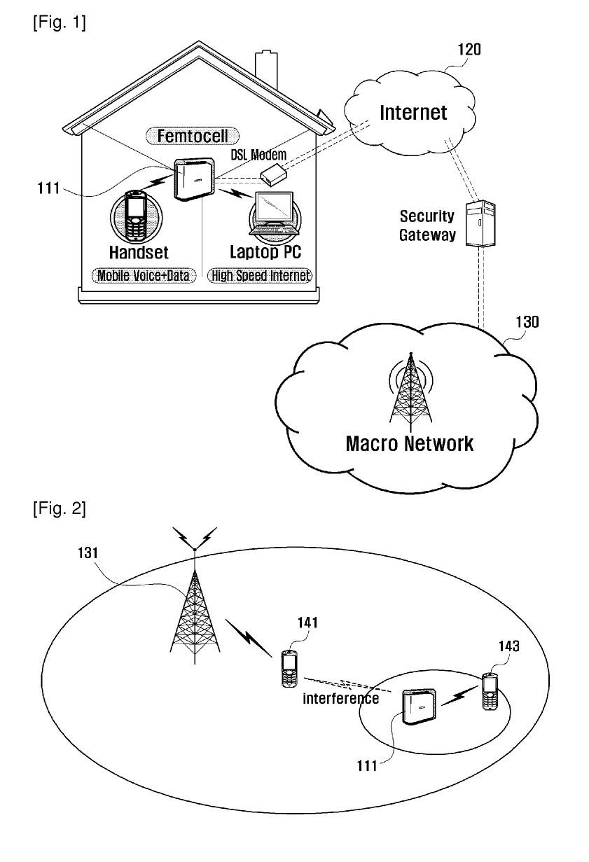

Referring to FIG. 7, the base station 510 operating in idle state checks the transmission transition period level, i.e. n, of the current frame (or slot) (711). That is, the base station 510 calculates the discontinuous transmission level n at the current frame (or slot). At this time, the discontinuous transmission cycle is determined in unit of DTX_Cycle_Unit frames (or slots). Accordingly, the discontinuous cycle number corresponding to the current subframe (or slot) is calculated as Math FIG. 1.

MathFigure 1

DTX_Cycle_no=floor (n/DTX_Cycle_Unit) [Math.1]

Next, the base station 510 determines whether the DTX_Cycle_Unit number is equal to T_Transition (713). If the DTX_Cycle_Unit number indicates a transition time point, the base station updates the discontinuous transmission cycle (715). That is, the base station 510 sets the current state identifier (Current_State) to 1, and resets the discontinuous transmission cycle (DTX_Cycle), i.e. P(x), and the transmission transition period (T_Transition), i.e. T(x) to the values corresponding to the current state identifier (Current_State).

If the DTX_Cycle_Unit number does not indicate the transition time point at step 713 or after the update of the discontinuous transmission cycle at 715, the base station 510 determines whether the current discontinuous transmission unit number indicates the discontinuous transmission cycle (717). At this time, the base station determines whether the DTX_Cycle_no+Offset mode DTX_cycle is 0. If it is determined that the current discontinuous transmission unit number indicates the discontinuous transmission cycle at step 717, the base station transmits the downlink signal (719) and, otherwise, returns to FIG. 6.

FIG. 8 is a flowchart illustrating an idle state operation method of a mobile terminal according to an exemplary embodiment of the present invention.

Referring to FIG. 8, the mobile station 530 performs the idle state operation every subframe (or slot) n as a physical layer transmission time unit (811). The mobile station 530 filters the signal carrying the downlink reference signal or pilot signal at specific time duration within every subframe (or slot), e.g. n_detect frame (or slot) (813). Next, the mobile terminal 530 determines whether the received signal strength is greater than a predetermined threshold value (815).

If it is determined that the received signal strength is greater than the threshold value, the mobile terminal 530 sets initial transmission power to the initial access signal power (817). Next, the mobile terminal 530 starts the access procedure (819).

Otherwise, if it is determined that the received signal strength is not greater than the threshold value, the mobile terminal repeats steps 811 to 819 until the downlink signal is detected. In the exemplary embodiment of FIG. 8, the mobile terminal 530 can starts the access procedure only when the downlink signal is detected.

In the wireless communication system according to an exemplary embodiment of the present invention, when the base station enters the idle state, it transmits the downlink signal at discontinuous transmission cycle; and the mobile terminal receives the downlink signal transmitted by the base station discontinuously and acquires the control information from the received downlink signal. That is, the base station transmits the downlink signal during the transmission cycle duration repeating at the first discontinuous transmission cycle within the first transmission transition period and, if the first transmission transition period elapses, transmits the downlink signal during the transmission cycle duration repeating at the second discontinuous transmission cycle within the second transmission transition period.

When no mobile terminal exists within the cell under the control of the base station or all the mobile terminals within the cell are in idle state, the base station enters the idle state. Before transitioning from the idle state to the connected state, the base station transmits the downlink signal in the discontinuous mode. The base station can transition from the idle state to the connected when it receives a connection request or the mobile terminal is connected to the base station.

The first and second transmission transition periods can be set to the same length or different lengths. The base station transmits the downlink signal at the end of the first discontinuous transmission cycle or after the transmission offset following the first discontinuous transmission cycle. The base station transmits the downlink signal at the end of the second discontinuous transmission cycle or after the transmission offset following the second discontinuous transmission cycle.

Since the base stations of the wireless communication transmit the downlink signal discontinuously, it is possible to avoid the downlink inter-cell interferences.

As described above, the wireless communication system and idle state operation method of the wireless communication system according to the present invention allows the base stations to transmit downlink signal discontinuously, thereby avoiding downlink inter-cell interferences.

### INDUSTRIAL APPLICABILITY

Although exemplary embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

1. An idle state operation method of a base station for a wireless communication, comprising:
setting a first discontinuous transmission cycle and a first transmission transition period;
transmitting downlink signals at the first discontinuous transmission cycle within the first transmission transition period;
setting a second discontinuous transmission cycle and a second transmission transition period when the first transmission transition period ends; and
transmitting the downlink signal at the second discontinuous transmission cycle within the second transmission transition period.

2. The idle state operation method of claim 1, wherein transmitting downlink signals at a first discontinuous transmission cycle within a first transmission transition period comprises repeating discontinuous transmission until the base station transitions from an idle state to a connected state.

3. The idle state operation method of claim 1, wherein the first transmission transition period and the second transmission transition period are identical with each other or different from each other in length.

4. The idle state operation method of claim 1, wherein transmitting downlink signals at a first discontinuous transmission cycle within a first transmission transition period comprises:
starting the transmission of the downlink signal at a time point where a transmission offset starting at a start point of the first transmission transition period ends; and
starting the transmission of the downlink signal at a time point where a transmission offset starting at an end point of the first transmission transition period.

5. The idle state operation method of claim 1, wherein transmitting downlink signals at a second discontinuous transmission cycle within a second transmission transition period comprises:
starting the transmission of the downlink signal at a time point where a transmission offset starting at a start point of the second transmission transition period ends; and
starting the transmission of the downlink signal at a time point where a transmission offset starting at an end point of the second transmission transition period.

6. The idle state operation method of claim 1, further comprising: entering the idle state when no mobile terminal exists or all mobile terminal in a cell of the base station are in idle state.

7. The idle state operation method of claim 1, wherein the downlink signal includes at least one of a reference signal, a pilot signal, and a control signal.

8. The idle state operation method of claim 2, further comprising transitioning, when an uplink access of a mobile terminal or a connection establishment with a mobile terminal is detected, from the idle state to a connected state.

9. A wireless communication system comprising:
a base station which sets a first discontinuous transmission cycle and a first transmission transition period, transmits downlink signals at the first discontinuous transmission cycle within the first transmission transition period, sets a second discontinuous transmission cycle and a second transmission transition period when the first transmission transition period ends, and transmits the downlink signal at the second discontinuous transmission cycle within the second transmission transition period; and
at least one mobile terminal which receives the downlink signal and acquires information by analyzing the received downlink signal.

10. The wireless communication system of claim 9, wherein the base station repeats discontinuous transmission until the base station transitions from an idle state to a connected state.

11. The wireless communication system of claim 9, wherein the first transmission transition period and the second transmission transition period are identical with each other or different from each other in length.

12. The wireless communication system of claim 9, wherein the downlink signal includes at least one of a reference signal, a pilot signal, and a control signal.

13. The wireless communication system of claim 9, wherein the base station starts the transmission of the downlink signal at a time point where a transmission offset starting at a start point of the first transmission transition period end and at a time point where a transmission offset starting at an end point of the first transmission transition period.

14. The wireless communication system of claim 9, wherein the base station starts the transmission of the downlink signal at a time point where a transmission offset starting at a start point of the second transmission transition period ends and at a time point where a transmission offset starting at an end point of the second transmission transition period.

15. The wireless communication system of claim 10, wherein the base station enters the idle state when no mobile terminal exists or all mobile terminal in a cell of the base station are in idle state.

16. The wireless communication system of claim 10, wherein the base station transitions, when an uplink access of a mobile terminal or a connection establishment with a mobile terminal is detected, from the idle state to a connected state.
